(19) United States
(12) Patent Application Publication
(10) Pub. No.: US 2024/0195853 A1
(43) Pub. Date: Jun. 13, 2024

(54) Connecting User Devices To A Virtual Whiteboard And Invoking A Video Conference From The Whiteboard

(71) Applicant: Zoom Video Communications, Inc., San Jose, CA (US)

(72) Inventors: Palmer Harold Batt, Seattle, WA (US); Alicia Anne-Kepner Brekke, Richmond, VA (US); Stephen George Newton, San Jose, CA (US); Jeffrey William Smith, Layton, UT (US)

(21) Appl. No.: 18/064,524

(22) Filed: Dec. 12, 2022

(51) Int. Cl. H04L 65/4038; G06F 3/14; G06V 10/74

(52) U.S. Cl. CPC H04L 65/4038; G06F 3/1454; G06V 10/761

(57) ABSTRACT

A system may connect user devices to a virtual whiteboard configured to output visual content to displays of the user devices. The system may invoke a video conference from the whiteboard to transmit, to the user devices, a message configured to connect the user devices to the video conference, and instantiate the whiteboard including the visual content output to the displays of the user devices within the video conference. In some implementations, the message may include context information (e.g., a title associated with the whiteboard, participants of the video conference, or an elapsed time of the video conference). In some implementations, the system may configure a graphical user interface (GUI) indicating users of the whiteboard. The GUI may be configured to receive selections of users to invite to the video conference.

### FIELD

This disclosure relates generally to video conferencing and, more specifically, to connecting user devices to a virtual whiteboard and invoking a video conference from the whiteboard.

### BRIEF DESCRIPTION OF THE DRAWINGS

This disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a block diagram of an example of an electronic computing and communications system.

FIG. 2 is a block diagram of an example internal configuration of a computing device of an electronic computing and communications system.

FIG. 3 is a block diagram of an example of a software platform implemented by an electronic computing and communications system.

FIG. 4 is a block diagram of an example of a system for connecting user devices to a virtual whiteboard and invoking a video conference from the whiteboard.

FIG. 5 is an illustration of an example of a graphical user interface (GUI) including a whiteboard including visual content.

FIG. 6 is an illustration of an example of a GUI configured to receive a selection for configuring a message to connect user devices to a video conference.

FIG. 7 is an illustration of an example of a GUI configured to receive a selection for accepting or declining a video conference.

FIG. 8 is an illustration of an example of a GUI associated with a video conference and a whiteboard, including visual content.

FIG. 9 is a flowchart of an example of a technique for connecting user devices to a virtual whiteboard and invoking a video conference from the whiteboard.

FIG. 10 is a flowchart of an example of a technique for displaying GUIs for connecting user devices to a virtual whiteboard and invoking a video conference from the whiteboard.

### DETAILED DESCRIPTION OF THE DRAWINGS

Enterprise entities rely upon several modes of communication to support their operations, including telephone, email, internal messaging, and the like. These separate modes of communication have historically been implemented by service providers whose services are not integrated with one another. The disconnect between these services, in at least some cases, requires information to be manually passed by users from one service to the next. Furthermore, some services, such as telephony services, are traditionally delivered via on-premises systems, meaning that remote workers and those who are generally increasingly mobile may be unable to rely upon them. One type of system which addresses problems such as these includes a unified communications as a service (UCaaS) platform, which includes several communications services integrated over a network, such as the Internet, to deliver a complete communication experience regardless of physical location.

Conventional collaboration software, such as that of a conventional UCaaS platform, may enable users to collaborate remotely with one another on projects or ideas using an online, interactive, shared workspace, such as a virtual whiteboard. For example, multiple users of the collaboration software can, via their user devices, connect to a server to simultaneously access pages of a whiteboard at the same time, including from different geographic locations. As part of the collaborative process, the users can, subject to various permissions, make changes to content of the whiteboard and see changes to the whiteboard being made by other users in real time. In some cases, users collaborating on a whiteboard may want to communicate in real time to address content, changes, or the like. For example, users of the collaboration software may want to connect with one another over a video conference within which the whiteboard content can be visually shared with the video conference participants. However, conventional collaboration software does not enable video conferences or real-time communications to be initiated between users directly from a whiteboard. As such, the user starting the video conference typically must take several manual actions through external software that facilitates a video conference, including determining which users to invite, sending invitations including a conference link to those users, and, once the video conference is in progress, selecting the correct whiteboard to share within the video conference (or, in some cases, creating a new whiteboard for the video conference). Thus, starting the video conference may be burdensome for users, typically involving multiple steps to bring users together and prepare particular content for discussion, and thus disruptive to the collaborative experience. Further, some users may find it inconvenient to join a video conference when the video conference is started, while other users who may otherwise want to join might not know about the video conference at all because they were unintentionally left out of the manually created invitation list.

Implementations of this disclosure address problems such as these by enabling a server device hosting an online, interactive, virtual whiteboard to transition users from asynchronous collaboration within the whiteboard to synchronous collaboration within a video conference currently sharing the whiteboard. A server device executing whiteboard software can connect user devices (e.g., associated with users of the whiteboard, such as content collaborators) to the whiteboard. The whiteboard may be configured to output visual content to displays of the user devices when collaborating. For example, the users can use virtual tools, such as draw, shape, and line tools, text editors, sticky notes, templates, image tools, erasers, and table editors, including with specified fonts, sizes, colors, widths and emphasis where applicable, to generate the visual content. The server device can invoke a video conference from the virtual whiteboard. For example, the video conference can be invoked by a user clicking a video conference button displayed in the whiteboard through a GUI. The video conference may be invoked from the whiteboard to transmit, to the user devices, a message configured to connect the user devices to the video conference (e.g., an invitation to the users to join the video conference). Further, the video conference may be invoked from the whiteboard to instantiate the whiteboard including the visual content output to the displays of the user devices within the video conference.

In some implementations, the message may include context information, such as a title associated with the whiteboard, participants of the video conference, or an elapsed time of the video conference, so that users can better decide whether to join the video conference. In some implementations, the server device may use a machine learning model, trained using visual content from previous whiteboards and/or transcription from previous video conferences, to determine additional users to invite to the video conference. In some implementations, the server device may access a calendar system to schedule the video conference with other users. In some implementations, the whiteboard could be a hybrid whiteboard including hardware and software components. As a result, to the extent that collaborating on a whiteboard asynchronously may cause difficulty for users, a user can initiate a video conference that selectively invites users to join and that instantiates the whiteboard with the visual content, ready for discussion, without requiring the user to locate the whiteboard with the visual content or generate a new whiteboard with new visual content.

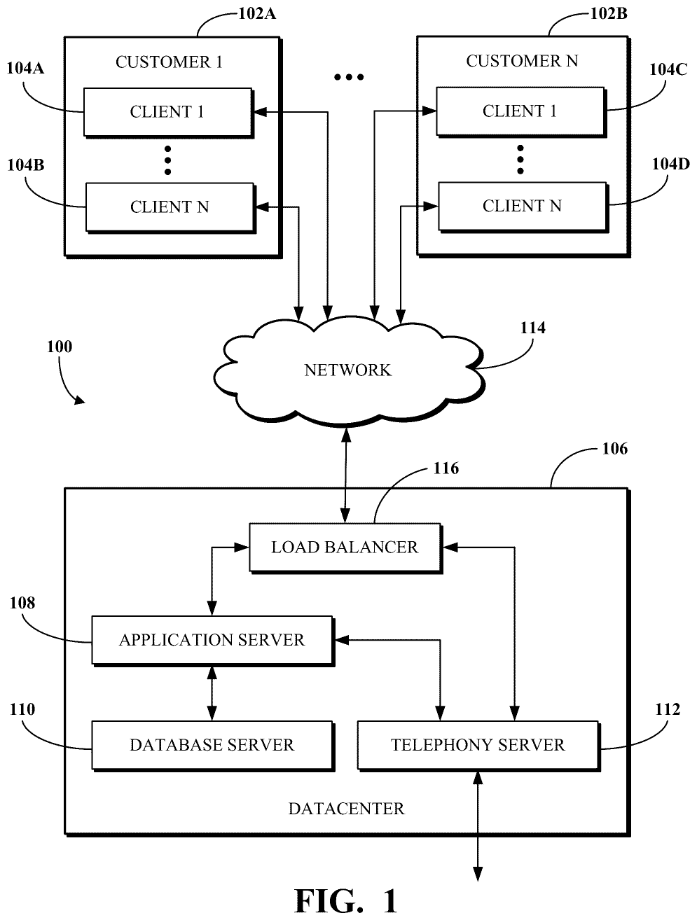

To describe some implementations in greater detail, reference is first made to examples of hardware and software structures used to implement a system for connecting user devices to a virtual whiteboard and invoking a video conference from the whiteboard. FIG. 1 is a block diagram of an example of an electronic computing and communications system 100, which can be or include a distributed computing system (e.g., a client-server computing system), a cloud computing system, a clustered computing system, or the like.

The system 100 includes one or more customers, such as customers 102A through 102B, which may each be a public entity, private entity, or another corporate entity or individual that purchases or otherwise uses software services, such as of a UCaaS platform provider. Each customer can include one or more clients. For example, as shown and without limitation, the customer 102A can include clients 104A through 104B, and the customer 102B can include clients 104C through 104D. A customer can include a customer network or domain. For example, and without limitation, the clients 104A through 104B can be associated or communicate with a customer network or domain for the customer 102A and the clients 104C through 104D can be associated or communicate with a customer network or domain for the customer 102B.

A client, such as one of the clients 104A through 104D, may be or otherwise refer to one or both of a client device or a client application. Where a client is or refers to a client device, the client can comprise a computing system, which can include one or more computing devices, such as a mobile phone, a tablet computer, a laptop computer, a notebook computer, a desktop computer, or another suitable computing device or combination of computing devices. Where a client instead is or refers to a client application, the client can be an instance of software running on a customer device (e.g., a client device or another device). In some implementations, a client can be implemented as a single physical unit or as a combination of physical units. In some implementations, a single physical unit can include multiple clients.

The system 100 can include a number of customers and/or clients or can have a configuration of customers or clients different from that generally illustrated in FIG. 1. For example, and without limitation, the system 100 can include hundreds or thousands of customers, and at least some of the customers can include or be associated with a number of clients.

The system 100 includes a datacenter 106, which may include one or more servers. The datacenter 106 can represent a geographic location, which can include a facility, where the one or more servers are located. The system 100 can include a number of datacenters and servers or can include a configuration of datacenters and servers different from that generally illustrated in FIG. 1. For example, and without limitation, the system 100 can include tens of datacenters, and at least some of the datacenters can include hundreds or another suitable number of servers. In some implementations, the datacenter 106 can be associated or communicate with one or more datacenter networks or domains, which can include domains other than the customer domains for the customers 102A through 102B.

The datacenter 106 includes servers used for implementing software services of a UCaaS platform. The datacenter 106 as generally illustrated includes an application server 108, a database server 110, and a telephony server 112. The servers 108 through 112 can each be a computing system, which can include one or more computing devices, such as a desktop computer, a server computer, or another computer capable of operating as a server, or a combination thereof. A suitable number of each of the servers 108 through 112 can be implemented at the datacenter 106. The UCaaS platform uses a multi-tenant architecture in which installations or instantiations of the servers 108 through 112 is shared amongst the customers 102A through 102B.

In some implementations, one or more of the servers 108 through 112 can be a non-hardware server implemented on a physical device, such as a hardware server. In some implementations, a combination of two or more of the application server 108, the database server 110, and the telephony server 112 can be implemented as a single hardware server or as a single non-hardware server implemented on a single hardware server. In some implementations, the datacenter 106 can include servers other than or in addition to the servers 108 through 112, for example, a media server, a proxy server, or a web server.

The application server 108 runs web-based software services deliverable to a client, such as one of the clients 104A through 104D. As described above, the software services may be of a UCaaS platform. For example, the application server 108 can implement all or a portion of a UCaaS platform, including conferencing software, messaging software, and/or other intra-party or inter-party communications software. The application server 108 may, for example, be or include a unitary Java Virtual Machine (JVM).

In some implementations, the application server 108 can include an application node, which can be a process executed on the application server 108. For example, and without limitation, the application node can be executed in order to deliver software services to a client, such as one of the clients 104A through 104D, as part of a software application. The application node can be implemented using processing threads, virtual machine instantiations, or other computing features of the application server 108. In some such implementations, the application server 108 can include a suitable number of application nodes, depending upon a system load or other characteristics associated with the application server 108. For example, and without limitation, the application server 108 can include two or more nodes forming a node cluster. In some such implementations, the application nodes implemented on a single application server 108 can run on different hardware servers.

The database server 110 stores, manages, or otherwise provides data for delivering software services of the application server 108 to a client, such as one of the clients 104A through 104D. In particular, the database server 110 may implement one or more databases, tables, or other information sources suitable for use with a software application implemented using the application server 108. The database server 110 may include a data storage unit accessible by software executed on the application server 108. A database implemented by the database server 110 may be a relational database management system (RDBMS), an object database, an XML database, a configuration management database (CMDB), a management information base (MIB), one or more flat files, other suitable non-transient storage mechanisms, or a combination thereof. The system 100 can include one or more database servers, in which each database server can include one, two, three, or another suitable number of databases configured as or comprising a suitable database type or combination thereof.

In some implementations, one or more databases, tables, other suitable information sources, or portions or combinations thereof may be stored, managed, or otherwise provided by one or more of the elements of the system 100 other than the database server 110, for example, the client 104 or the application server 108.

The telephony server 112 enables network-based telephony and web communications from and to clients of a customer, such as the clients 104A through 104B for the customer 102A or the clients 104C through 104D for the customer 102B. Some or all of the clients 104A through 104D may be voice over internet protocol (VOIP)-enabled devices configured to send and receive calls over a network 114. In particular, the telephony server 112 includes a session initiation protocol (SIP) zone and a web zone. The SIP zone enables a client of a customer, such as the customer 102A or 102B, to send and receive calls over the network 114 using SIP requests and responses. The web zone integrates telephony data with the application server 108 to enable telephony-based traffic access to software services run by the application server 108. Given the combined functionality of the SIP zone and the web zone, the telephony server 112 may be or include a cloud-based private branch exchange (PBX) system.

The SIP zone receives telephony traffic from a client of a customer and directs same to a destination device. The SIP zone may include one or more call switches for routing the telephony traffic. For example, to route a VOIP call from a first VOIP-enabled client of a customer to a second VOIP-enabled client of the same customer, the telephony server 112 may initiate a SIP transaction between a first client and the second client using a PBX for the customer. However, in another example, to route a VOIP call from a VOIP-enabled client of a customer to a client or non-client device (e.g., a desktop phone which is not configured for VOIP communication) which is not VOIP-enabled, the telephony server 112 may initiate a SIP transaction via a VOIP gateway that transmits the SIP signal to a public switched telephone network (PSTN) system for outbound communication to the non-VOIP-enabled client or non-client phone. Hence, the telephony server 112 may include a PSTN system and may in some cases access an external PSTN system.

The telephony server 112 includes one or more session border controllers (SBCs) for interfacing the SIP zone with one or more aspects external to the telephony server 112. In particular, an SBC can act as an intermediary to transmit and receive SIP requests and responses between clients or non-client devices of a given customer with clients or non-client devices external to that customer. When incoming telephony traffic for delivery to a client of a customer, such as one of the clients 104A through 104D, originating from outside the telephony server 112 is received, a SBC receives the traffic and forwards it to a call switch for routing to the client.

In some implementations, the telephony server 112, via the SIP zone, may enable one or more forms of peering to a carrier or customer premise. For example, Internet peering to a customer premise may be enabled to case the migration of the customer from a legacy provider to a service provider operating the telephony server 112. In another example, private peering to a customer premise may be enabled to leverage a private connection terminating at one end at the telephony server 112 and at the other end at a computing aspect of the customer environment. In yet another example, carrier peering may be enabled to leverage a connection of a peered carrier to the telephony server 112.

In some such implementations, a SBC or telephony gateway within the customer environment may operate as an intermediary between the SBC of the telephony server 112 and a PSTN for a peered carrier. When an external SBC is first registered with the telephony server 112, a call from a client can be routed through the SBC to a load balancer of the SIP zone, which directs the traffic to a call switch of the telephony server 112. Thereafter, the SBC may be configured to communicate directly with the call switch.

The web zone receives telephony traffic from a client of a customer, via the SIP zone, and directs same to the application server 108 via one or more Domain Name System (DNS) resolutions. For example, a first DNS within the web zone may process a request received via the SIP zone and then deliver the processed request to a web service which connects to a second DNS at or otherwise associated with the application server 108. Once the second DNS resolves the request, it is delivered to the destination service at the application server 108. The web zone may also include a database for authenticating access to a software application for telephony traffic processed within the SIP zone, for example, a softphone.

The clients 104A through 104D communicate with the servers 108 through 112 of the datacenter 106 via the network 114. The network 114 can be or include, for example, the Internet, a local area network (LAN), a wide area network (WAN), a virtual private network (VPN), or another public or private means of electronic computer communication capable of transferring data between a client and one or more servers. In some implementations, a client can connect to the network 114 via a communal connection point, link, or path, or using a distinct connection point, link, or path. For example, a connection point, link, or path can be wired, wireless, use other communications technologies, or a combination thereof.

The network 114, the datacenter 106, or another element, or combination of elements, of the system 100 can include network hardware such as routers, switches, other network devices, or combinations thereof. For example, the datacenter 106 can include a load balancer 116 for routing traffic from the network 114 to various servers associated with the datacenter 106. The load balancer 116 can route, or direct, computing communications traffic, such as signals or messages, to respective elements of the datacenter 106. For example, the load balancer 116 can operate as a proxy, or reverse proxy, for a service, such as a service provided to one or more remote clients, such as one or more of the clients 104A through 104D, by the application server 108, the telephony server 112, and/or another server. Routing functions of the load balancer 116 can be configured directly or via a DNS. The load balancer 116 can coordinate requests from remote clients and can simplify client access by masking the internal configuration of the datacenter 106 from the remote clients.

In some implementations, the load balancer 116 can operate as a firewall, allowing or preventing communications based on configuration settings. Although the load balancer 116 is depicted in FIG. 1 as being within the datacenter 106, in some implementations, the load balancer 116 can instead be located outside of the datacenter 106, for example, when providing global routing for multiple datacenters. In some implementations, load balancers can be included both within and outside of the datacenter 106. In some implementations, the load balancer 116 can be omitted.

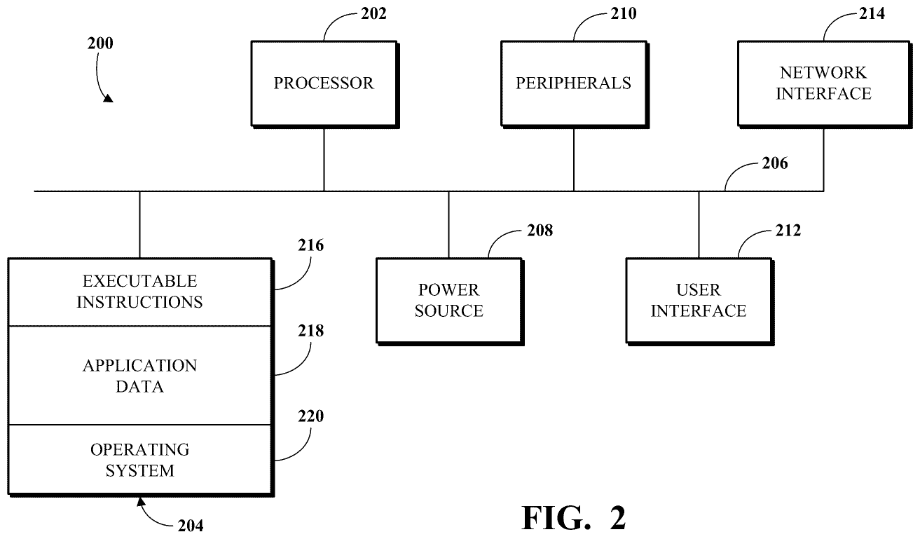

FIG. 2 is a block diagram of an example internal configuration of a computing device 200 of an electronic computing and communications system. In one configuration, the computing device 200 may implement one or more of the client 104, the application server 108, the database server 110, or the telephony server 112 of the system 100 shown in FIG. 1.

The computing device 200 includes components or units, such as a processor 202, a memory 204, a bus 206, a power source 208, peripherals 210, a user interface 212, a network interface 214, other suitable components, or a combination thereof. One or more of the memory 204, the power source 208, the peripherals 210, the user interface 212, or the network interface 214 can communicate with the processor 202 via the bus 206.

The processor 202 is a central processing unit, such as a microprocessor, and can include single or multiple processors having single or multiple processing cores. Alternatively, the processor 202 can include another type of device, or multiple devices, configured for manipulating or processing information. For example, the processor 202 can include multiple processors interconnected in one or more manners, including hardwired or networked. The operations of the processor 202 can be distributed across multiple devices or units that can be coupled directly or across a local area or other suitable type of network. The processor 202 can include a cache, or cache memory, for local storage of operating data or instructions.

The memory 204 includes one or more memory components, which may each be volatile memory or non-volatile memory. For example, the volatile memory can be random access memory (RAM) (e.g., a DRAM module, such as DDR DRAM). In another example, the non-volatile memory of the memory 204 can be a disk drive, a solid state drive, flash memory, or phase-change memory. In some implementations, the memory 204 can be distributed across multiple devices. For example, the memory 204 can include network-based memory or memory in multiple clients or servers performing the operations of those multiple devices.

The memory 204 can include data for immediate access by the processor 202. For example, the memory 204 can include executable instructions 216, application data 218, and an operating system 220. The executable instructions 216 can include one or more application programs, which can be loaded or copied, in whole or in part, from non-volatile memory to volatile memory to be executed by the processor 202. For example, the executable instructions 216 can include instructions for performing some or all of the techniques of this disclosure. The application data 218 can include user data, database data (e.g., database catalogs or dictionaries), or the like. In some implementations, the application data 218 can include functional programs, such as a web browser, a web server, a database server, another program, or a combination thereof. The operating system 220 can be, for example, Microsoft Windows®, Mac OS X®, or Linux®; an operating system for a mobile device, such as a smartphone or tablet device; or an operating system for a non-mobile device, such as a mainframe computer.

The power source 208 provides power to the computing device 200. For example, the power source 208 can be an interface to an external power distribution system. In another example, the power source 208 can be a battery, such as where the computing device 200 is a mobile device or is otherwise configured to operate independently of an external power distribution system. In some implementations, the computing device 200 may include or otherwise use multiple power sources. In some such implementations, the power source 208 can be a backup battery.

The peripherals 210 includes one or more sensors, detectors, or other devices configured for monitoring the computing device 200 or the environment around the computing device 200. For example, the peripherals 210 can include a geolocation component, such as a global positioning system location unit. In another example, the peripherals can include a temperature sensor for measuring temperatures of components of the computing device 200, such as the processor 202. In some implementations, the computing device 200 can omit the peripherals 210.

The user interface 212 includes one or more input interfaces and/or output interfaces. An input interface may, for example, be a positional input device, such as a mouse, touchpad, touchscreen, or the like; a keyboard; or another suitable human or machine interface device. An output interface may, for example, be a display, such as a liquid crystal display, a cathode-ray tube, a light emitting diode display, virtual reality display, or other suitable display.

The network interface 214 provides a connection or link to a network (e.g., the network 114 shown in FIG. 1). The network interface 214 can be a wired network interface or a wireless network interface. The computing device 200 can communicate with other devices via the network interface 214 using one or more network protocols, such as using Ethernet, transmission control protocol (TCP), internet protocol (IP), power line communication, an IEEE 802.X protocol (e.g., Wi-Fi, Bluetooth, or ZigBee), infrared, visible light, general packet radio service (GPRS), global system for mobile communications (GSM), code-division multiple access (CDMA), Z-Wave, another protocol, or a combination thereof.

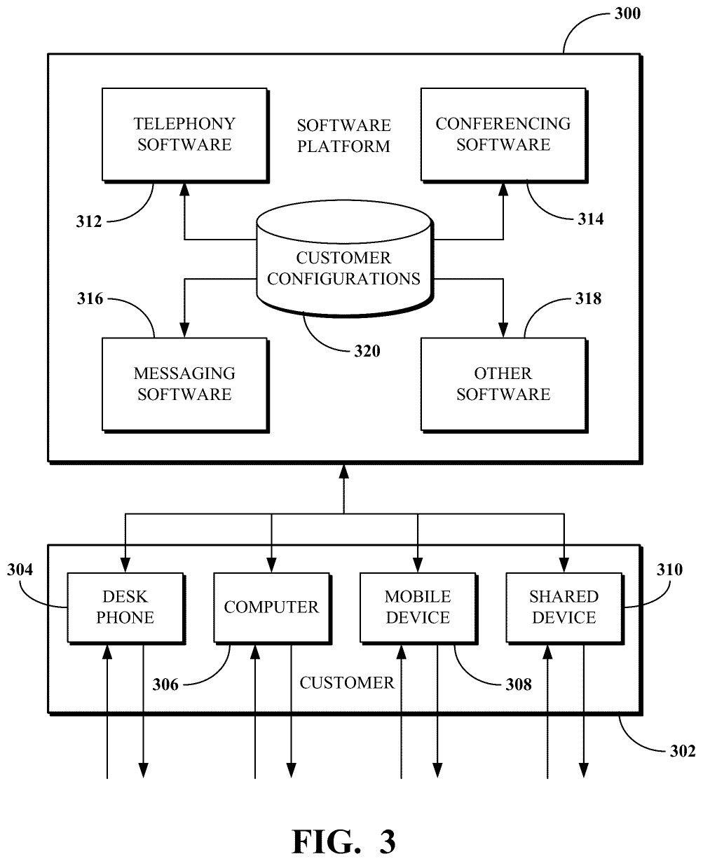

FIG. 3 is a block diagram of an example of a software platform 300 implemented by an electronic computing and communications system, for example, the system 100 shown in FIG. 1. The software platform 300 is a UCaaS platform accessible by clients of a customer of a UCaaS platform provider, for example, the clients 104A through 104B of the customer 102A or the clients 104C through 104D of the customer 102B shown in FIG. 1. The software platform 300 may be a multi-tenant platform instantiated using one or more servers at one or more datacenters including, for example, the application server 108, the database server 110, and the telephony server 112 of the datacenter 106 shown in FIG. 1.

The software platform 300 includes software services accessible using one or more clients. For example, a customer 302 as shown includes four clients—a desk phone 304, a computer 306, a mobile device 308, and a shared device 310. The desk phone 304 is a desktop unit configured to at least send and receive calls and includes an input device for receiving a telephone number or extension to dial to and an output device for outputting audio and/or video for a call in progress. The computer 306 is a desktop, laptop, or tablet computer including an input device for receiving some form of user input and an output device for outputting information in an audio and/or visual format. The mobile device 308 is a smartphone, wearable device, or other mobile computing aspect including an input device for receiving some form of user input and an output device for outputting information in an audio and/or visual format. The desk phone 304, the computer 306, and the mobile device 308 may generally be considered personal devices configured for use by a single user. The shared device 310 is a desk phone, a computer, a mobile device, or a different device which may instead be configured for use by multiple specified or unspecified users.

Each of the clients 304 through 310 includes or runs on a computing device configured to access at least a portion of the software platform 300. In some implementations, the customer 302 may include additional clients not shown. For example, the customer 302 may include multiple clients of one or more client types (e.g., multiple desk phones or multiple computers) and/or one or more clients of a client type not shown in FIG. 3 (e.g., wearable devices or televisions other than as shared devices). For example, the customer 302 may have tens or hundreds of desk phones, computers, mobile devices, and/or shared devices.

The software services of the software platform 300 generally relate to communications tools but are in no way limited in scope. As shown, the software services of the software platform 300 include telephony software 312, conferencing software 314, messaging software 316, and other software 318. Some or all of the software 312 through 318 uses customer configurations 320 specific to the customer 302. The customer configurations 320 may, for example, be data stored within a database or other data store at a database server, such as the database server 110 shown in FIG. 1.

The telephony software 312 enables telephony traffic between ones of the clients 304 through 310 and other telephony-enabled devices, which may be other ones of the clients 304 through 310, other VOIP-enabled clients of the customer 302, non-VOIP-enabled devices of the customer 302, VOIP-enabled clients of another customer, non-VOIP-enabled devices of another customer, or other VOIP-enabled clients or non-VOIP-enabled devices. Calls sent or received using the telephony software 312 may, for example, be sent or received using the desk phone 304, a softphone running on the computer 306, a mobile application running on the mobile device 308, or using the shared device 310 that includes telephony features.

The telephony software 312 further enables phones that do not include a client application to connect to other software services of the software platform 300. For example, the telephony software 312 may receive and process calls from phones not associated with the customer 302 to route that telephony traffic to one or more of the conferencing software 314, the messaging software 316, or the other software 318.

The conferencing software 314 enables audio, video, and/or other forms of conferences between multiple participants, such as to facilitate a conference between those participants. In some cases, the participants may all be physically present within a single location, for example, a conference room, in which the conferencing software 314 may facilitate a conference between only those participants and using one or more clients within the conference room. In some cases, one or more participants may be physically present within a single location and one or more other participants may be remote, in which the conferencing software 314 may facilitate a conference between all of those participants using one or more clients within the conference room and one or more remote clients. In some cases, the participants may all be remote, in which the conferencing software 314 may facilitate a conference between the participants using different clients for the participants. The conferencing software 314 can include functionality for hosting, presenting scheduling, joining, or otherwise participating in a conference. The conferencing software 314 may further include functionality for recording some or all of a conference and/or documenting a transcript for the conference.

The messaging software 316 enables instant messaging, unified messaging, and other types of messaging communications between multiple devices, such as to facilitate a chat or other virtual conversation between users of those devices. The unified messaging functionality of the messaging software 316 may, for example, refer to email messaging which includes a voicemail transcription service delivered in email format.

The other software 318 enables other functionality of the software platform 300. Examples of the other software 318 include, but are not limited to, device management software, resource provisioning and deployment software, administrative software, third party integration software, and the like. In one particular example, the other software 318 can include digital collaboration software for instantiating a virtual whiteboard and/or software for connecting user devices to a virtual whiteboard and invoking a video conference from the whiteboard. In some such cases, the conferencing software 314 may include the other software 318.

The software 312 through 318 may be implemented using one or more servers, for example, of a datacenter such as the datacenter 106 shown in FIG. 1. For example, one or more of the software 312 through 318 may be implemented using an application server, a database server, and/or a telephony server, such as the servers 108 through 112 shown in FIG. 1. In another example, one or more of the software 312 through 318 may be implemented using servers not shown in FIG. 1, for example, a meeting server, a web server, or another server. In yet another example, one or more of the software 312 through 318 may be implemented using one or more of the servers 108 through 112 and one or more other servers. The software 312 through 318 may be implemented by different servers or by the same server.

Features of the software services of the software platform 300 may be integrated with one another to provide a unified experience for users. For example, the messaging software 316 may include a user interface element configured to initiate a call with another user of the customer 302. In another example, the telephony software 312 may include functionality for elevating a telephone call to a conference. In yet another example, the conferencing software 314 may include functionality for sending and receiving instant messages between participants and/or other users of the customer 302. In yet another example, the conferencing software 314 may include functionality for file sharing between participants and/or other users of the customer 302. In some implementations, some, or all, of the software 312 through 318 may be combined into a single software application run on clients of the customer, such as one or more of the clients 304 through 310.

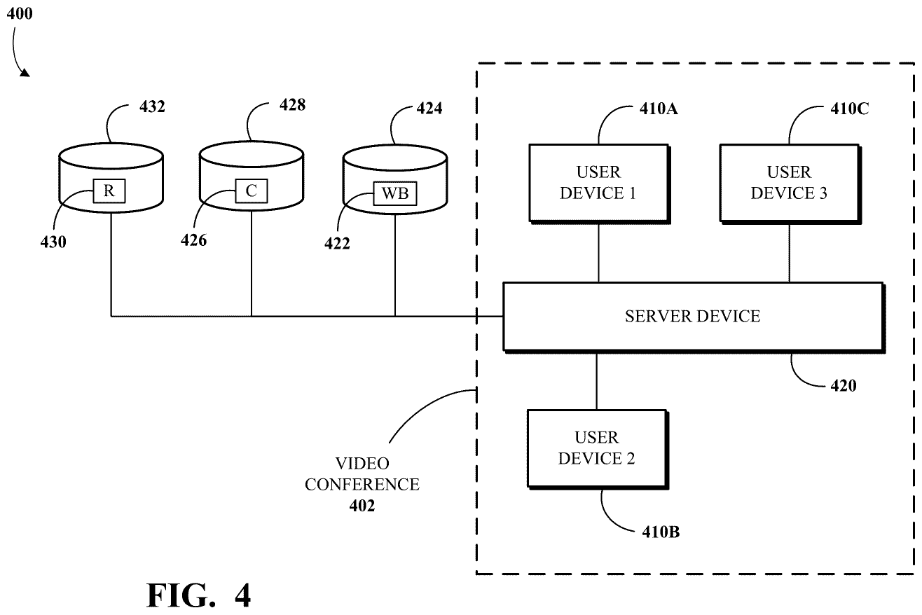

FIG. 4 is a block diagram of an example of a system 400 for connecting user devices to a whiteboard 422 and invoking a video conference 402 from the whiteboard 422. The system 400 may include user devices 410A to 410C and a server device 420. Each of the user devices 410A to 410C may be a client device such as one of the clients 104A through 104D shown in FIG. 1 or 304 through 310 shown in FIG. 3. Although three user devices 410A to 410C are shown and described by example, other numbers of participant devices may be used with the system 400. A user device such as the user devices 410A to 410C may execute software (e.g., client-side conferencing software, which could, for example, be via a client application or a web application used to connect to a conference implemented using server-side conferencing software, such as the conferencing software 314 shown in FIG. 3) and may connect to the server device 420. The server device 420 may execute software (e.g., server-side conferencing software, such as the conferencing software 314) to support the video conference 402 between users using the user devices 410A to 410C. For example, the server device 420 could be a server at the datacenter 106 shown in FIG. 1, such as the application server 108 or the telephony server 112.

The whiteboard 422 may be an online, interactive, virtual whiteboard, stored in a data structure 424. Generally, the whiteboard 422 is a software component served to one or more user devices, such as a user of the user device 410A (e.g., a first user) and a user of the user device 410B (e.g., a second user), from a server device 420. However, in some implementations, the whiteboard 422 could be a hybrid whiteboard including hardware components (e.g., in a physical room) and software components. The server device 420 executing whiteboard software (e.g., the other software 318) can connect the one or more user devices to the whiteboard 422. For example, the first user of the user device 410A and the second user of the user device 410B could be content collaborators working on the whiteboard 422 together. The whiteboard 422 may be configured to output visual content of the whiteboard 422 to displays of the user devices 410A and 410B when those devices 410A and 410B are connected to the whiteboard 422 (i.e., via the whiteboard software). For example, the first user and the second user can use virtual tools, such as draw, shape, and line tools, text editors, sticky notes, templates, image tools, erasers, and table editors, including with specified fonts, sizes, colors, widths and emphasis where applicable, to generate the visual content associated with the whiteboard 422.

The server device 420 can invoke a video conference 402 from the whiteboard 422. The video conference 402 can be invoked by a user interacting with a GUI object associated with the whiteboard (e.g., clicking a video conference button displayed by the whiteboard 422 through a GUI). The video conference 402 may be invoked from a first user device (e.g., the user device 410A) via the whiteboard 422. In response to the invocation of the video conference 402 from the first user device, a message configured to connect one or more other user devices to the video conference 402, such as the user device 410B and a user device 410C (e.g., used by a third user) may be transmitted to those one or more other user devices. For example, the message could be an invitation to the second user and the third user to join the video conference 402. In some implementations, the server device 420, via the whiteboard software, may recommend the users to invite to the video conference 402 based on properties of the whiteboard 422 that exist when the video conference 402 is invoked. For example, the server device 420 may recommend the second user based on the user device 410B being connected to the whiteboard 422 when the video conference 402 is invoked. In another example, the server device 420 may recommend the third user based on the third user being an owner of the whiteboard 422, the third user having subscribed to receive notifications related to the whiteboard 422, or the third user being an expert related to at least some of the content of the whiteboard 422. In some cases, the first user, in invoking the video conference 402, may provide input to the server device 420 to select the users for inviting to the video conference, such as the second user using the user device 410B and the third user using the user device 410C. The server device 420 may thus transmit messages based on the input to the user devices 410B and 410C. For example, the first user, in invoking the video conference 402, may provide the input by selecting the second user and the third user via a GUI configured to receive such selections for configuring the message.

The messages may be configured to connect the receiving user devices (e.g., the user devices 410B and 410C) to the video conference 402. For example, the messages may include an option for each user to accept or decline an invitation to join the video conference 402. Accepting the invitation to join may automatically connect a user device to the video conference 402, such as by routing the user device through a communications channel that may be encrypted to the video conference 402. The first user, having clicked the video conference button to invoke the video conference 402, may be determined by the server device 420 to be the host of the video conference 402, with the user device 410A being configured as a host device with controls for controlling the video conference 402 (e.g., which may supersede controls by other user devices). The second user and the third user, having accepted the invitation to join the video conference 402, may be determined by the server device 420 to be participants of the video conference 402, with the user devices 410B and 410C being configured as participant devices (e.g., which may have less control of the video conference 402 than the host device). As a result of accepting a video conference invitation via a message, the second user and the third user, using the user devices 410B and 410C, can access the video conference 402 (e.g., join as participants), and the first user using the user device 410A can control the video conference 402 (e.g., host the meeting).

Invoking the video conference 402 from the whiteboard 422 causes the whiteboard 422 to be output to the displays of the user devices 410A to 410C connected to the video conference 402. For example, the whiteboard 422, which may include visual content prepared by users of the whiteboard software (e.g., users of the user devices 410A and 410B) before the video conference 402 started, may be automatically instantiated in the video conference 402. The whiteboard 422 is automatically presented to the participants of the video conference 402 based on the invocation of the video conference 402 from the whiteboard 422. In particular, the whiteboard software facilitating the whiteboard 422 and the conferencing software facilitating the video conference 402 may correspond to separate software services (e.g., of a software platform, such as the software platform 300). When the virtual conference 402 is invoked from the whiteboard 422, the whiteboard software serves the whiteboard 422 to the conferencing software facilitating the video conference 402 so that the conferencing software can serve the whiteboard 422 within the video conference 402. As a result, any changes made to the whiteboard 422 within the video conference 402 (i.e., additions of new content or modifications or removals of content pre-existing the instantiation of the video conference 402) are captured by the whiteboard software to update the whiteboard 422 in real-time (i.e., to update data representative of the whiteboard 422 within a data store). To the extent that collaborating on the whiteboard 422 asynchronously may cause difficulty for the first user and the second user, either user (e.g., the first user in this case) can initiate the video conference 402. The user who initiates the video conference 402 can thus selectively invite other users (e.g., the second user and the third user in this case) to join the video conference 402 based on properties associated with the other users. The whiteboard 422, with the visual content, may be output in the video conference 402, ready for discussion by the users, without requiring any of the users to locate the whiteboard 422 with the visual content or generate a new whiteboard with new visual content.

In some implementations, the server device 420 may use a machine learning model, trained using visual content from previous whiteboards and/or transcription from previous video conferences, to determine additional users to invite to the video conference 402. For example, the server device 420 may use the machine learning model to recommend the user of the user device 410C (e.g., the third user), based on the machine learning model determining the user to be an expert related to the visual content associated with the whiteboard 422. The machine learning model could make the determination by matching the visual content associated with the whiteboard 422 to visual content from previous whiteboards associated with the user, or to transcription from previous video conferences including the user. The machine learning model may be trained using historical information, including previous visual content from previous whiteboards, and/or transcriptions from previous video conferences. For example, the machine learning model can be trained using a training data set including data samples representing parameters for historical whiteboards, including visual content, and historical video conferences. The training data set can enable the machine learning model to learn patterns, such as associations between particular users and particular visual content. The training can be periodic, such as by updating the machine learning model on a discrete time interval basis (e.g., once per week or month), or otherwise. The training data set may derive from multiple users (e.g., the users of the user devices 410A to 410C) or may be specific to a particular user (e.g., the user of the user device 410C). The training data set may omit certain data samples that are determined to be outliers. The machine learning model may, for example, be or include one or more of a neural network (e.g., a convolutional neural network, recurrent neural network, deep neural network, or other neural network), decision tree, vector machine, Bayesian network, cluster-based system, genetic algorithm, deep learning system separate from a neural network, or other machine learning model.

In some implementations, the server device 420 may access a calendar system 426, stored in a data structure 428, to schedule the video conference 402 with the users of the user devices 410A to 410C. For example, the calendar system 426 may include availabilities (e.g., dates, times, and/or physical locations) of the users for the video conference 402. This may enable the server device 420 to determine schedule information for the video conference 402, so that the video conference 402 can take place at a date, time, and/or physical location that is convenient for the users (e.g., 30 minutes from now, or at the start of the next hour, as opposed to a default configuration in which the video conference 402 begins immediately when the video conference button is selected, and the messages are sent). The messages, which are configured to connect user devices to the video conference 402 (e.g., the user devices 410B and 410C), may include the schedule information (e.g., a date, a time, and/or a physical location for the video conference 402) so that users receiving the messages can determine whether to accept or decline the invitation to join the video conference 402. Accepting the invitation by a user may cause an appointment to be generated for the user in the calendar system 426.

In some implementations, the server device 420 may access a reservation system 430, stored in a data structure 432, to reserve a physical resource for the video conference 402. Physical resources may include, for example, rooms, computing resources, such as phones, smartphones, smart TVs, monitors, cameras, microphones, computers, laptops, tablets, digital whiteboards, touch screens, and the like, some of which may include conferencing software integrated therein, and non-computing resources, such as rooms, desks, chairs, and the like. In some implementations, the server device 420 may coordinate a reservation of a physical resource, via the reservation system 430, with schedule information for the video conference 402, via the calendar system 426. In some cases, the server device 420 may detect locations of users of user devices associated with the video conference 402. For example, the reservation system 430 may include location information associated with the users, or the server device 420 may access geolocation information associated with the user devices. The server device 420 may detect that one or more users are in proximity to one another, and may access the reservation system 430 to reserve a physical resource for the users, based on the proximity, for use during the video conference 402. For example, the server device 420 may detect that the users of the user devices 410A to 410C are in a same physical building, and may access the reservation system 430 to reserve a room in the building for the users to use during the video conference 402.

In some implementations, the server device 420 may determine a set of permissions for users using the user devices to access the whiteboard 422 in the video conference 402. For example, the set of permissions may determine a level of access and/or interaction that a user may have with the whiteboard 422, such as viewing and/or editing of the visual content. The set of permissions for users using the user devices to access the whiteboard 422 in the video conference 402 may be based on access the users may have to the whiteboard 422 and/or interactions by those users with the whiteboard 422 before the video conference. For example, the users of the user devices 410A and 410B may have permission to edit the visual content, or could be restricted to viewing, before the video conference. In the video conference 402, the users of the user devices 410A and 410B may continue to have permission to edit the visual content, or could continue to be restricted to viewing. In some implementations, the visual content may include an embedded file, and the set of permissions may correspond to permissions associated with the embedded file. As a result, the users of the user devices 410A and 410B may continue to edit or view the visual content during the video conference. In some implementations, the access may change during the video conference. For example, a host of the video conference may change a user's permissions from view to edit, or from edit to view.

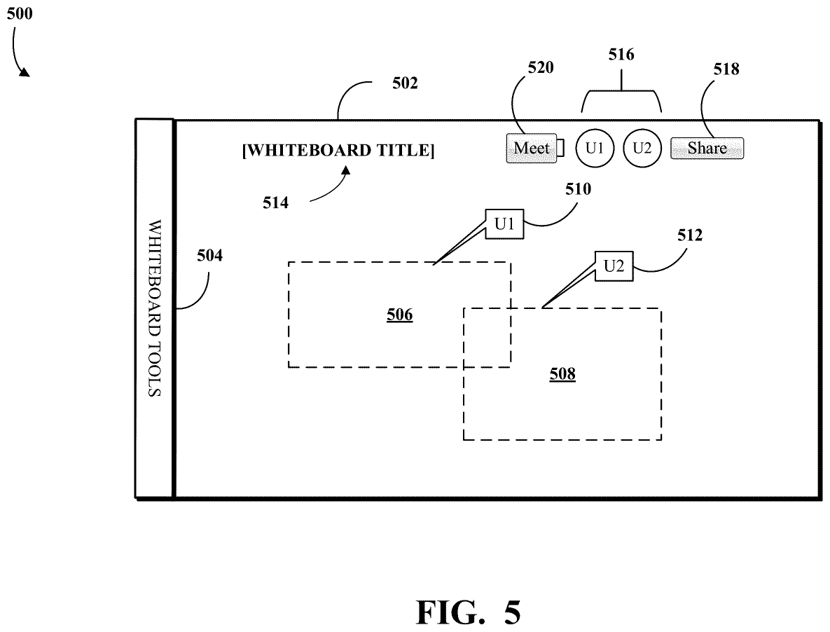

FIG. 5 is an illustration of an example of a GUI 500 including a whiteboard 502. For example, the whiteboard 502 could be the whiteboard 422 shown in FIG. 4. The GUI 500 could be output to displays of user devices connected to the whiteboard 502 before a video conference begins, such as the user devices 410A and 410B. The whiteboard 502 may include whiteboard tools 504. For example, the whiteboard tools 504 may include virtual tools, such as draw, shape, and line tools, text editors, sticky notes, templates, image tools, erasers, and tables editors, including with specified fonts, sizes, colors, widths and emphasis where applicable, to generate visual content. The whiteboard 502 may display the visual content generated by the users in real time, such as first visual content 506 generated by a first user (e.g., the user of the user device 410A, referred to as “U1” in FIG. 5) and second visual content 508 generated by a second user (e.g., the user of the user device 410B, referred to as “U2” in FIG. 5). The users may use the whiteboard tools 504 to create the visual content, and in some cases, the visual content may include one or more embedded files (e.g., the file, and in some cases, the content of the file). Further, the users may see each other's creations of visual content in the GUI 500, including with user tags associated with the visual content. For example, a first user tag 510, associated with the first visual content 506, and a second user tag 512, associated with the second visual content 508, may be displayed in the GUI 500 to show creations of the first visual content 506 by the first user and the second visual content 508 by the second user.

The GUI 500 may display a title 514 associated with the whiteboard 502 (e.g., the title may be manually entered by a user, or automatically generated by the whiteboard software). The GUI 500 may display an identifier 516 that indicates the users that are presently connected to the whiteboard 502. For example, the identifier 516 may indicate that the first user (e.g., “U1”) and the second user (e.g., “U2”) are presently connected to the whiteboard 502. The GUI 500 may display a share button 518 (e.g., “share”) for sharing the whiteboard 502 with other users (e.g., before the video conference starts). For example, selecting the share button 518 by a user could cause the whiteboard 502 to be shared with another user, such as a third user (e.g., the user of the user device 410C, which could be connected to the whiteboard 502 before the video conference starts if shared with the user).

The GUI 500 may display a video conference button 520 (e.g., “meet”) for invoking a video conference from the whiteboard 502. This may enable transitioning from asynchronous collaboration between users of the whiteboard 502 to synchronous collaboration between the users in a video conference that shares the whiteboard 502. For example, selecting the video conference button 520 by a user could invoke a video conference, such as the video conference 402. Thus, the video conference could be invoked based on receiving an input, via the video conference button 520, from a user of a user device, such as the first user or the second user.

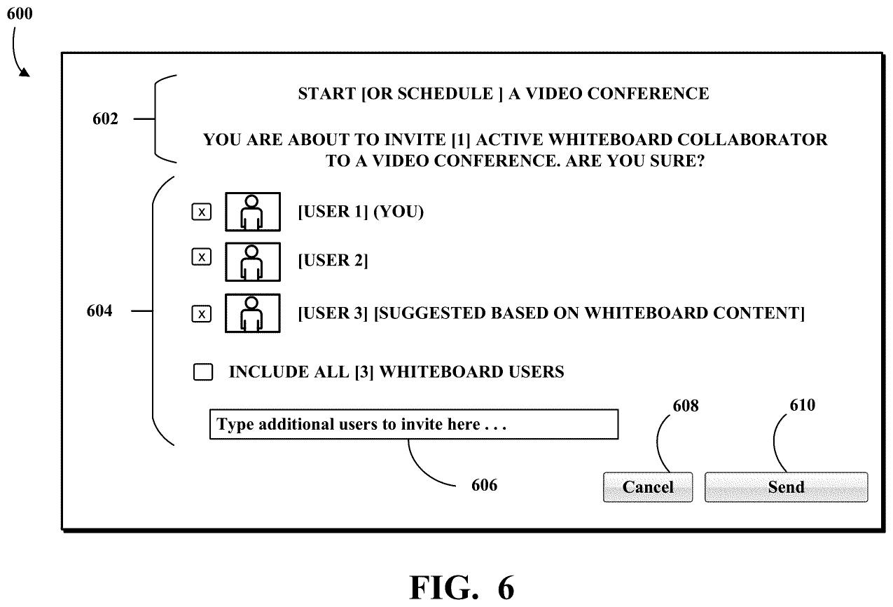

FIG. 6 is an illustration of an example of a GUI 600 configured to receive a selection for configuring a message to connect user devices to a video conference. For example, the GUI 600 could be output to a display of user device connected to the whiteboard 502 before a video conference begins. In particular, the GUI 600 could be output to the display of the user device that provided the input to select the video conference button (e.g., the video conference button 520), such as the display of the user device 410A when the first user selects the video conference button.

The GUI 600 may display notification information 602 to the user. The notification information 602 may indicate that the user is now starting, or will be scheduling, a video conference, and that the user is currently inviting some number of other users to the video conference. The number of other users being invited may be users that are connected to the whiteboard (e.g., the second user, using the user device 410B). The GUI 600 may display selection options 604 to the user which may indicate users to invite to the video conference. For example, the options may include check boxes that a user can select or de-select. A first option, associated with a first check box, may indicate inviting the user that selected the video conference button (e.g., the first user). In some cases, the user that selected the video conference button might not join the video conference, but instead recommend the video conference to other users (e.g., the second user, using the user device 410B, and a third user, using the user device 410C). A second option, associated with a second check box, may indicate inviting a user that is currently connected to the whiteboard (e.g., the second user, using the user device 410B). A third option, associated with a third check box, may indicate inviting a user that is recommended to join the video conference (e.g., the third user, using the user device 410C). For example, the server device 420, using the machine learning model, may recommend the third user. The recommendation may be based on a property, such as the third user being an owner of whiteboard, the third user having subscribed to receive notifications related to the whiteboard, or the third user being an expert related to the first visual content 506 and/or the second visual content 508. A fourth option, associated with a fourth check box, may indicate inviting all users that are connected to the whiteboard, and/or all users that are recommended to join the video conference. In some cases, the user may manually enter additional users to invite to the video conference, using additional user devices, such as via a manual user entry 606.

The GUI 600 may display a cancel button 608 (e.g., “Cancel”) for canceling invocation of the video conference. This may return the user to the whiteboard (e.g., the whiteboard 502). The GUI 600 may display a transmit button 610 (e.g., “Send”) for transmitting one or more messages, based on one or more of the selections (e.g., via the selection options 604), to the invited users using the user devices (e.g., the second user, using the user device 410B, and the third user, using the user device 410C). The messages may be configured to connect the user devices that receive the messages to the video conference. In some implementations, when scheduling a video conference (e.g., via the calendar system 426), as opposed to immediately starting a video conference, the transmit button 610 could be for transmitting one or more meeting invitations or requests. The meeting invitations may be based on schedule information (e.g., a date, a time, and/or a physical location, determined by using the calendar system).

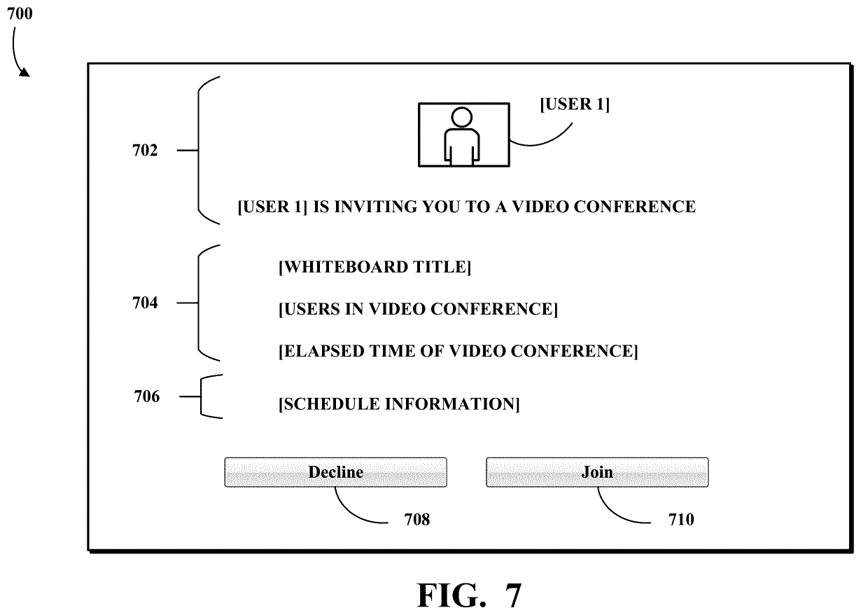

FIG. 7 is an illustration of an example of a GUI 700 configured to receive a selection for accepting or declining a video conference. For example, the GUI 700 could be output to a display of a user device based on receiving the message to connect their user device to a video conference, such as the video conference 402 (e.g., a notification or meeting invitation). In some cases, the GUI 700 could be output to a display of a user device that is connected to a whiteboard (e.g., the whiteboard 422, or the whiteboard 502). For example, the GUI 700 could be output to the display of the user device used by the second user (e.g., the user device 410B). In some cases, the GUI 700 could be output to a display of a user device that is not connected to the whiteboard. For example, the GUI 700 could be output to the display of the user device used by the third user (e.g., the user device 410C).

In some implementations, the GUI 700 may display notification information 702 to the user, which may indicate that the user is being invited by another user to a video conference that is now starting or will be starting at a later time based on schedule information. In some implementations, the GUI 700 may display context information 704 to the user. The context information 704 may include, for example, a title associated with the whiteboard (e.g., the title 514), users in the video conference (e.g., participants that have already joined, such as the first user, using the user device 410A), an elapsed time of the video conference (e.g., an amount of time in which the video conference has been ongoing), and users that have been invited the video conference (e.g., invited, but not yet joined). The context information 704 may enable the user receiving the context information 704 to better decide whether to join the video conference.

In some implementations, the GUI 700 may display schedule information 706 to the user (e.g., when the video conference is being scheduled for a later time). The schedule information 706 may include a time, a date, and/or a physical location for the video conference. The schedule information 706 may be determined, for example, by accessing the calendar system 426 to schedule the video conference, and/or the reservation system 430 to reserve the physical location.

The GUI 700 may display a decline button 708 (e.g., “Decline”) for declining the invitation to join the video conference. In some implementations, declining the invitation may close the whiteboard for the user that declines based on the whiteboard being moved to the video conference. In some implementations, declining the invitation may cause the whiteboard to be duplicated in the video conference, so that the user that declines can continue to work in a first copy of the whiteboard while a user that accepts can continue to work in a second copy of the whiteboard in the video conference. The GUI 700 may display an accept button 710 (e.g., “Join”) for accepting the invitation to join the video conference. A user selecting the accept button 710 may automatically connect the user device to the video conference, such as by routing the user device through a communications channel that may be encrypted to the video conference. For example, the second user selecting the accept button 710, through the GUI 700 displayed at an output interface of the user device 410B, may connect the user device 410B to the video conference, and the third user selecting the accept button 710, through the GUI 700 displayed at an output interface of the user device 410C, may connect the user device 410C to the video conference. In some implementations, selecting the accept button 710 may schedule the video conference for the user, such as on the user's calendar, so that that user can join the video conference at a later time when scheduled.

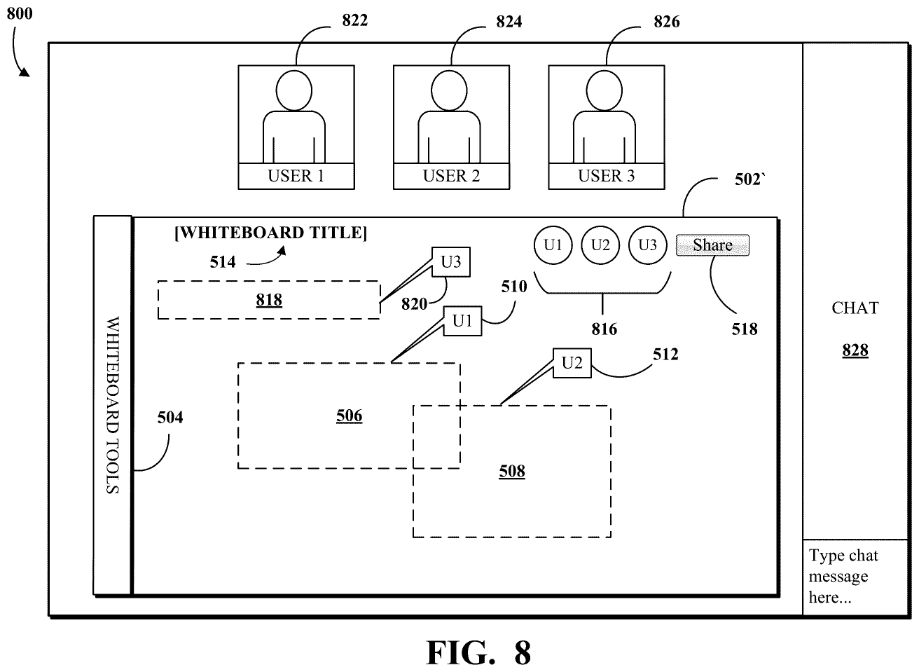

FIG. 8 is an illustration of an example of a GUI 800 associated with a video conference (e.g., the video conference 402) and a whiteboard 502′ (e.g., an instantiation of the whiteboard 422, or the whiteboard 502, in the video conference 402). For example, the GUI 800 could be output to a display of user devices connected to the video conference, such as the user device 410A (e.g., connected to the video conference after transmitting the message) and the user devices 410B and 410C (e.g., connected to the video conference after accepting in the message). The video conference may be invoked from the whiteboard 502 to instantiate the whiteboard 502′, including the visual content output, to the displays of the user devices within the video conference. For example, the video conference may be invoked from the whiteboard 502, such as by a user selecting the video conference button 520 shown in FIG. 5. The whiteboard 502 may be automatically instantiated in the video conference, including with the whiteboard tools 504, the first visual content 506, the second visual content 508, and the title 514. This may enable the visual content to be available for immediate use during the video conference by the users of the user devices, such as the first user, the second user, and the third user, using the user device 410A, the user device 410B, and the user device 410C, respectively. The whiteboard 502′, with the visual content, may be instantiated in the video conference, ready for discussion by the first user, the second user, and the third user, without requiring any of the users to locate the whiteboard with the visual content (e.g., the whiteboard 502) or generate a new whiteboard with new visual content. The identifier 816 may indicate that the first user (e.g., “U1”), the second user (e.g., “U2”), and the third user (e.g., “U3”) are presently connected to the whiteboard 502″ via the video conference 402.

The first user, using the user device 410A, may be assigned as the host of the video conference (e.g., the user device 410A may be the host device with host controls). The assignment may be based on the first user selecting a video conference button (e.g., the video conference button 520) from the whiteboard (e.g., the whiteboard 502) to invoke the video conference. The second user, using the user device 410B, and the third user, using the user device 410C, may be assigned as participants of the video conference (e.g., the user devices 410B and 410C may be participant devices without host controls). The assignment may be based on the second user and third user receiving messages (e.g., initiated by the first user, using the user device 410A) to connect their user devices to the video conference.

During the video conference, the whiteboard 502 may be updated to display additional visual content generated by the users in real time during the video conference. For example, the whiteboard 502′ may be updated to display a third visual content 818 generated by the third user (e.g., the user of the user device 410C, referred to as “U3” in FIG. 8). The users may use the whiteboard tools 504 to update the visual content. Further, the users may see each other's creations of visual content in the GUI 800, including with user tags associated with the visual content. For example, the first user tag 510, associated with the first visual content 506, the second user tag 512, associated with the second visual content 508, and a third user tag 820, associated with the third visual content 818, may be displayed in the GUI 800 to show creations by the first user, the second user, and the third user, respectively.

The participants of the video conference (e.g., the first user, the second user, and the third user), via the user devices being connected thereto (e.g., the user devices 410A to 410C), may advantageously communicate with one another during the video conference, such as by speaking to one another using cameras and microphones, chatting with one another using keyboards and screens, and seeing video feeds of one another in user tiles using cameras and screens. For example, the GUI 800 may display user tiles associated with the users that are participating in the video conference, such as a first user tile 822 associated with the first user, a second user tile 824 associated with the second user, and a third user tile 826 associated with the third user. The GUI 800 may display a chat area 828 to enable the users to see chat messages sent to one another. As a result, a whiteboard (e.g., the whiteboard 502) with the visual content (e.g., the first visual content 506 and the second visual content 508), may be initiated in the video conference (e.g., the whiteboard 502), so that the whiteboard is ready for discussion, without requiring any of the users to locate the whiteboard or generate a new whiteboard with new visual content.

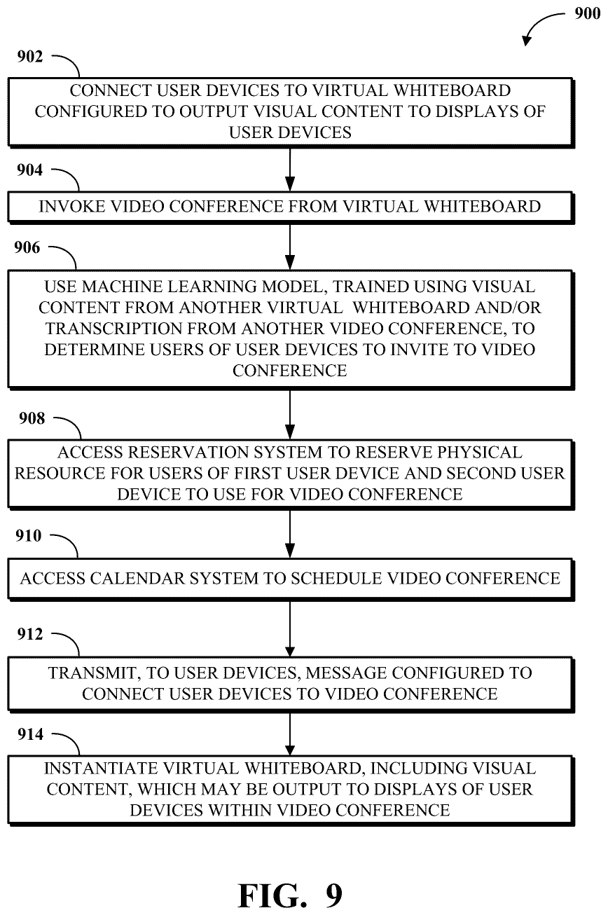

To further describe some implementations in greater detail, reference is next made to examples of techniques which may be performed by or using a system for connecting user devices to a virtual whiteboard and invoking a video conference from the whiteboard. FIG. 9 is a flowchart of an example of a technique 900 for invoking a video conference from a whiteboard. The technique 900 can be executed using computing devices, such as the systems, hardware, and software described with respect to FIGS. 1-8. The technique 900 can be performed, for example, by executing a machine-readable program or other computer-executable instructions, such as routines, instructions, programs, or other code. The steps, or operations, of the technique 900 or another technique, method, process, or algorithm described in connection with the implementations disclosed herein can be implemented directly in hardware, firmware, software executed by hardware, circuitry, or a combination thereof.

For simplicity of explanation, the technique 900 is depicted and described herein as a series of steps or operations. However, the steps or operations in accordance with this disclosure can occur in various orders and/or concurrently. Additionally, other steps or operations not presented and described herein may be used. Furthermore, not all illustrated steps or operations may be required to implement a technique in accordance with the disclosed subject matter.

At 902, a device (e.g., the server device 420) may connect user devices to a whiteboard (e.g., the whiteboard 422, or the whiteboard 502) configured to output visual content to displays of user devices (e.g., displays of the user devices 410A and 410B). For example, the device may connect the user devices 410A and 410B to the whiteboard 502. The whiteboard may be configured to output visual content (e.g., the first visual content 506 and the second visual content 508) to displays of the user devices (e.g., the user devices 410A and 410B), before a video conference begins. For example, a GUI (e.g., the GUI 500) could be output to displays of the user devices connected to the whiteboard to output the visual content.

At 904, the device may invoke a video conference from the whiteboard. For example, the video conference 402 can be invoked by a user (e.g., using the user device 410A) clicking a video conference button (e.g., the video conference button 520) displayed in the whiteboard through the GUI. The video conference may be invoked by the user, for example, due to difficulty collaborating with another user on the whiteboard.

At 906, the device may use a machine learning model, trained using visual content from another whiteboard and/or a transcription from another video conference, to determine users of user devices to invite to the video conference. For example, the device may use a machine learning model to recommend a user of a user device based on determining the user to be connected to the whiteboard, an owner of whiteboard, subscribed to receive notifications related to the whiteboard, or an expert related to the visual content associated with the whiteboard. The machine learning model could make the determination by matching the visual content associated with the whiteboard to visual content from previous whiteboards associated with the user of the user device, or to transcription from previous video conferences including the user of the user device.

At 908, the device may access a reservation system to reserve a physical resource for users of a first user device and a second user device to use for the video conference. For example, the device may access the reservation system 430, stored in the data structure 432, to reserve a physical resource for the video conference. Physical resources may include, computing resources, such as phones, smartphones, smart TVs, monitors, cameras, microphones, computers, laptops, tablets, digital whiteboards, touch screens, and the like, some of which may include conferencing software integrated therein, and non-computing resources, such as rooms, desks, chairs, and the like.

At 910, the device may access a calendar system to schedule the video conference. For example, the device may access the calendar system 426, stored in the data structure 428, to schedule the video conference with the users of the user devices. The calendar system may include availabilities (e.g., dates, times, and/or physical location locations) of the users for the video conference. This may enable the device to determine schedule information for the video conference, so that the video conference can take place at a date, time, and/or physical location that is convenient for the users.

At 912, the device may transmit, to the user devices, a message configured to connect the user devices to the video conference. For example, the device may transmit, to one or more user devices, such as the user device 410B the user device 410C, a message configured to connect the user devices to the video conference. The message could be an invitation to the users of the user devices to join the video conference. The message may include the schedule information (e.g., a date, a time, and/or a physical location for the video conference), so that users receiving the messages can determine whether to accept or decline the invitation to join the video conference.

At 912, the device may instantiate the whiteboard, including the visual content, which may be output to the displays of user devices within the video conference. For example, the video conference may be invoked from the whiteboard to instantiate the whiteboard including the visual content, which may be output to the displays of the user devices, such as the user devices 410A to 410C, during the video conference. For example, the whiteboard, with the visual content prepared by the users of the user devices from before the video conference started, may be automatically instantiated in the video conference. This may enable the visual content to be available for immediate use by the users of the user devices during the video conference.

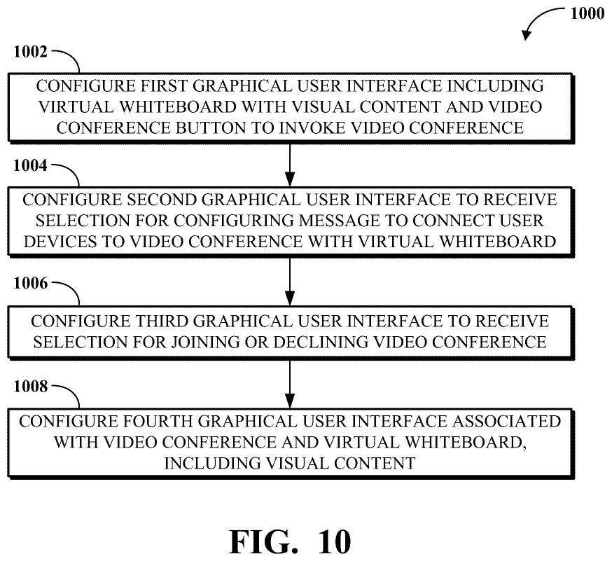

FIG. 10 is a flowchart of an example of a technique 1000 for displaying multiple GUIs for connecting user devices to a virtual whiteboard and invoking a video conference from the whiteboard. The technique 1000 can be executed using computing devices, such as the systems, hardware, and software described with respect to FIGS. 1-8. The technique 1000 can be performed, for example, by executing a machine-readable program or other computer-executable instructions, such as routines, instructions, programs, or other code. The steps, or operations, of the technique 1000 or another technique, method, process, or algorithm described in connection with the implementations disclosed herein can be implemented directly in hardware, firmware, software executed by hardware, circuitry, or a combination thereof.

For simplicity of explanation, the technique 1000 is depicted and described herein as a series of steps or operations. However, the steps or operations in accordance with this disclosure can occur in various orders and/or concurrently. Additionally, other steps or operations not presented and described herein may be used. Furthermore, not all illustrated steps or operations may be required to implement a technique in accordance with the disclosed subject matter.

At 1002, a device (e.g., the server device 420) may configure a first GUI including a whiteboard with visual content and a video conference button to invoke a video conference. For example, the device may configure the GUI 500 including the whiteboard 502 including the first visual content 506 and the second visual content 508, and the video conference button 520, to invoke the video conference (e.g., the video conference 402). The first GUI could be output to displays of user devices that are connected to the whiteboard, such as the user devices 410A and 410B.

At 1004, the device may configure a second GUI to receive a selection for configuring a message to connect the user devices to the video conference with the whiteboard. For example, the device may configure the GUI 600 to receive a selection, via the selection options 604, for configuring a message to connect user devices to the video conference (e.g., the user devices 410A to 410C). The second GUI could be output to a display of a user device that is connected to the whiteboard, and which provides input selecting the video conference button, such as the user devices 410A.

At 1006, the device may configure a third GUI to receive a selection for accepting or declining the video conference. For example, the device may configure the GUI 700 to receive a selection, via the decline button 708 or the accept button 710, for accepting or declining the video conference. The second GUI could be output to a display of a user device that is receives the message, such as the user devices 410B and 410C.

At 1008, the device may configure a fourth GUI associated with the video conference and the whiteboard, including the visual content. For example, the device may configure the GUI 800 associated with the video conference and the whiteboard, including the visual content, during the video conference. The fourth GUI could be output to displays of user devices that are connected to the video conference, such as the user devices 410A to 410C.

Some implementations may include a method that includes connecting user devices to a virtual whiteboard configured to output visual content to displays of the user devices; and invoking a video conference from the whiteboard to transmit, to the user devices, a message configured to connect the user devices to the video conference; and instantiate the whiteboard including the visual content output to the displays of the user devices within the video conference. In some implementations, the message includes context information including at least one of a title associated with the whiteboard, participants of the video conference, or an elapsed time of the video conference. In some implementations, the method includes configuring a GUI for display at an output interface of a first user device, the GUI indicating users of the whiteboard, wherein the GUI is configured to receive selections of users to invite to the video conference. In some implementations, the method includes using a machine learning model, trained using at least one of visual content from another whiteboard or a transcription from another video conference, to determine a user of an additional user device to invite to the video conference. In some implementations, the method includes detecting a first user and a second user of the user devices in physical proximity to one another; and accessing a reservation system to reserve a physical resource for the first user and the second user to use for the video conference. In some implementations, the method includes determining a set of permissions for users using the user devices to access the whiteboard within the video conference, wherein the set of permissions is based on access to the whiteboard granted to users before connecting to the video conference. In some implementations, the method includes accessing a calendar system to schedule the video conference, wherein the message includes schedule information including a time for the video conference. In some implementations, the method includes transmitting a notification of the video conference to a user of an additional user device that is not connected to the whiteboard.

Some implementations may include an apparatus that includes a memory and a processor. The processor may be configured to execute instructions stored in the memory to: connect user devices to a virtual whiteboard configured to output visual content to displays of the user devices; and invoke a video conference from the whiteboard to: transmit, to the user devices, a message configured to connect the user devices to the video conference; and instantiate the whiteboard including the visual content output to the displays of the user devices within the video conference. In some implementations, the processor is further configured to execute instructions stored in the memory to configure a GUI for display at an output interface of a first user device, the GUI including a button to invoke the video conference. In some implementations, the processor is further configured to execute instructions stored in the memory to configure a GUI for display at an output interface of a first user device during the video conference, the GUI including user tiles associated with users of the user devices. In some implementations, the processor is further configured to execute instructions stored in the memory to invoke the video conference based on receiving an input, associated with the whiteboard, from a first user device; and assign the first user device as a host device that controls the video conference. In some implementations, the processor is further configured to execute instructions stored in the memory to configure a GUI for display at an output interface of a first user device during the video conference, the GUI including the message with context information including at least one of a title associated with the whiteboard, participants of the video conference, or an elapsed time of the video conference. In some implementations, the processor is further configured to execute instructions stored in the memory to access a reservation system to reserve a room for users of a first user device and a second user device to use for the video conference. In some implementations, the processor is further configured to execute instructions stored in the memory to transmit a notification of the video conference to a user of an additional user device based on the user being an owner of the whiteboard.

Some implementations may include a non-transitory computer readable medium that stores instructions operable to cause one or more processors to perform operations that include connecting user devices to a virtual whiteboard configured to output visual content to displays of the user devices; and invoking a video conference from the whiteboard to: transmit, to the user devices, a message configured to connect the user devices to the video conference; and instantiate the whiteboard including the visual content output to the displays of the user devices within the video conference. In some implementations, operations may include configuring a GUI for display at an output interface of a first user device, the GUI including a button to invoke the video conference. In some implementations, operations may include using a machine learning model, trained using at least one of visual content from another whiteboard or a transcription from another video conference, to determine a user of an additional user device to invite to the video conference. In some implementations, operations may include including context information in the message, the context information including at least one of a title associated with the whiteboard, participants of the video conference, or an elapsed time of the video conference. In some implementations, operations may include scheduling the video conference based on availability of users of the user devices according to a calendar system.

The implementations of this disclosure can be described in terms of functional block components and various processing operations. Such functional block components can be realized by a number of hardware or software components that perform the specified functions. For example, the disclosed implementations can employ various integrated circuit components (e.g., memory elements, processing elements, logic elements, look-up tables, and the like), which can carry out a variety of functions under the control of one or more microprocessors or other control devices. Similarly, where the elements of the disclosed implementations are implemented using software programming or software elements, the systems and techniques can be implemented with a programming or scripting language, such as C, C++, Java, JavaScript, assembler, or the like, with the various algorithms being implemented with a combination of data structures, objects, processes, routines, or other programming elements.

Functional aspects can be implemented in algorithms that execute on one or more processors. Furthermore, the implementations of the systems and techniques disclosed herein could employ a number of conventional techniques for electronics configuration, signal processing or control, data processing, and the like. The words “mechanism” and “component” are used broadly and are not limited to mechanical or physical implementations, but can include software routines in conjunction with processors, etc. Likewise, the terms “system” or “tool” as used herein and in the figures, but in any event based on their context, may be understood as corresponding to a functional unit implemented using software, hardware (e.g., an integrated circuit, such as an ASIC), or a combination of software and hardware. In certain contexts, such systems or mechanisms may be understood to be a processor-implemented software system or processor-implemented software mechanism that is part of or callable by an executable program, which may itself be wholly or partly composed of such linked systems or mechanisms.

Implementations or portions of implementations of the above disclosure can take the form of a computer program product accessible from, for example, a computer-usable or computer-readable medium. A computer-usable or computer-readable medium can be a device that can, for example, tangibly contain, store, communicate, or transport a program or data structure for use by or in connection with a processor. The medium can be, for example, an electronic, magnetic, optical, electromagnetic, or semiconductor device.

Other suitable mediums are also available. Such computer-usable or computer-readable media can be referred to as non-transitory memory or media and can include volatile memory or non-volatile memory that can change over time. The quality of memory or media being non-transitory refers to such memory or media storing data for some period of time or otherwise based on device power or a device power cycle. A memory of an apparatus described herein, unless otherwise specified, does not have to be physically contained by the apparatus, but is one that can be accessed remotely by the apparatus, and does not have to be contiguous with other memory that might be physically contained by the apparatus.

While the disclosure has been described in connection with certain implementations, it is to be understood that the disclosure is not to be limited to the disclosed implementations but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A method, comprising:
connecting user devices to a virtual whiteboard configured to output visual content to displays of the user devices; and
invoking a video conference from the whiteboard to:
transmit, to the user devices, a message configured to connect the user devices to the video conference; and
instantiate the whiteboard including the visual content output to the displays of the user devices within the video conference.

2. The method of claim 1, wherein the message includes context information including at least one of a title associated with the whiteboard, participants of the video conference, or an elapsed time of the video conference.

3. The method of claim 1, further comprising:
configuring a graphical user interface (GUI) for display at an output interface of a first user device, the GUI indicating users of the whiteboard, wherein the GUI is configured to receive selections of users to invite to the video conference.

4. The method of claim 1, further comprising:
using a machine learning model, trained using at least one of visual content from another whiteboard or a transcription from another video conference, to determine a user of an additional user device to invite to the video conference.

5. The method of claim 1, further comprising:
detecting a first user and a second user of the user devices in physical proximity to one another; and
accessing a reservation system to reserve a physical resource for the first user and the second user to use for the video conference.

6. The method of claim 1, further comprising:
determining a set of permissions for users using the user devices to access the whiteboard within the video conference, wherein the set of permissions is based on access to the whiteboard granted to users before connecting to the video conference.

7. The method of claim 1, further comprising:
accessing a calendar system to schedule the video conference, wherein the message includes schedule information including a time for the video conference.

8. The method of claim 1, further comprising:
transmitting a notification of the video conference to a user of an additional user device that is not connected to the whiteboard.

9. An apparatus, comprising:
a memory; and
a processor configured to execute instructions stored in the memory to:
connect user devices to a virtual whiteboard configured to output visual content to displays of the user devices; and
invoke a video conference from the whiteboard to:
transmit, to the user devices, a message configured to connect the user devices to the video conference; and
instantiate the whiteboard including the visual content output to the displays of the user devices within the video conference.

10. The apparatus of claim 9, wherein the processor is further configured to execute instructions stored in the memory to:
configure a GUI for display at an output interface of a first user device, the GUI including a button to invoke the video conference.

11. The apparatus of claim 9, wherein the processor is further configured to execute instructions stored in the memory to:
configure a GUI for display at an output interface of a first user device during the video conference, the GUI including user tiles associated with users of the user devices.

12. The apparatus of claim 9, wherein the processor is further configured to execute instructions stored in the memory to:
invoke the video conference based on receiving an input, associated with the whiteboard, from a first user device; and
assign the first user device as a host device that controls the video conference.

13. The apparatus of claim 9, wherein the processor is further configured to execute instructions stored in the memory to:
configure a GUI for display at an output interface of a first user device during the video conference, the GUI including the message with context information including at least one of a title associated with the whiteboard, participants of the video conference, or an elapsed time of the video conference.

14. The apparatus of claim 9, wherein the processor is further configured to execute instructions stored in the memory to:
access a reservation system to reserve a room for users of a first user device and a second user device to use for the video conference.

15. The apparatus of claim 9, wherein the processor is further configured to execute instructions stored in the memory to:
transmit a notification of the video conference to a user of an additional user device based on the user being an owner of the whiteboard.

16. A non-transitory computer readable medium storing instructions operable to cause one or more processors to perform operations comprising:
connecting user devices to a virtual whiteboard configured to output visual content to displays of the user devices; and
invoking a video conference from the whiteboard to:
transmit, to the user devices, a message configured to connect the user devices to the video conference; and
instantiate the whiteboard including the visual content output to the displays of the user devices within the video conference.

17. The non-transitory computer readable medium storing instructions of claim 16, the operations further comprising:
configuring a GUI for display at an output interface of a first user device, the GUI including a button to invoke the video conference.

18. The non-transitory computer readable medium storing instructions of claim 16, the operations further comprising:
using a machine learning model, trained using at least one of visual content from another whiteboard or a transcription from another video conference, to determine a user of an additional user device to invite to the video conference.

19. The non-transitory computer readable medium storing instructions of claim 16, the operations further comprising:
including context information in the message, the context information including at least one of a title associated with the whiteboard, participants of the video conference, or an elapsed time of the video conference.

20. The non-transitory computer readable medium storing instructions of claim 16, the operations further comprising:
scheduling the video conference based on availability of users of the user devices according to a calendar system.
